(19) United States
(12) Patent Application Publication
(10) Pub. No.: US 2012/0056905 A1
(43) Pub. Date: Mar. 8, 2012

(54) IMAGE DISPLAY APPARATUS AND INFORMATION PROCESSING APPARATUS

(76) Inventors: Ryosuke NONAKA, Yokohama-shi (JP); Masahiro BABA, Yokohama-shi (JP); Yuma SANO, Kawasaki-shi (JP)

(21) Appl. No.: 13/072,094

(22) Filed: Mar. 25, 2011

(30) Foreign Application Priority Data
Sep. 6, 2010 (JP) 2010-199264

(51) Int. Cl. G09G 3/36; G09G 5/10

(52) U.S. Cl. 345/690; 345/87

(57) ABSTRACT

In one embodiment, an image display apparatus is disclosed. The apparatus includes a liquid crystal panel, a backlight, a calculation unit, a reference unit, a multiplier unit, and a determination unit. The backlight includes light sources illuminating the liquid crystal panel unit. The calculation unit calculates a representative value of relative luminances of pixels in the each of small regions into which the display region is divided. The reference unit refers to prestored lighting pattern data items for the light sources. The multiplier unit multiplies, for each of the small regions, the referred lighting pattern data item by the representative value. The determination unit determines emission intensities of respective light sources based on multiplication results of the multiplier unit.

### CROSS-REFERENCE TO RELATED APPLICATIONS

This application is based upon and claims the benefit of priority from Japanese Patent Application No. 2010-199264, filed Sep. 6, 2010; the entire contents of which are incorporated herein by reference.

### FIELD

Embodiments described herein relate generally to an image display and an information processing apparatus.

### BACKGROUND

In conventional liquid crystal display (LCD), back light has a plurality of light source. Luminance of each light source is controlled respectively. Each back light illuminates a region dividing the screen of the LCD In a conventional liquid crystal display (LCD), luminances of light sources included in the backlight of the LCD are controlled by dividing the screen of the LCD, for the purposes of, for example, increasing the display dynamic range and reducing the consumption of power. For instance, the first luminance of a backlight in each region is determined based on the representative value of a video signal in said each region, and the second luminance of the backlight in said each region is determined using a linear space filter that holds a weight coefficient applied to the first luminance.

However, in an LCD apparatus of, for example, an edge-light type in which the luminance distribution of a single light source is anisotropic, there is a problem that when an object is displayed, the brightness of the object will significantly vary depending upon where on the screen the object is displayed.

### BRIEF DESCRIPTION OF THE DRAWINGS

FIG. 1 is a block diagram illustrating an image display according to a first embodiment;

FIG. 2 is a view illustrating arrangement examples of light sources incorporated in the backlight shown in FIG. 1;

FIG. 3 is a block diagram illustrating an example of the emission intensity calculation unit (information processing apparatus) shown in FIG. 1;

FIG. 4 is a block diagram illustrating another example of the emission intensity calculation unit (information processing apparatus) shown in FIG. 1;

FIG. 5 is a view illustrating display region division examples corresponding to FIG. 2;

FIG. 6 is a view illustrating arrangement examples of small regions into which the division examples shown in FIG. 5 are further divided;

FIG. 7 is a view useful in explaining the operation of the reference unit shown in FIG. 3;

FIG. 8 is a view useful in explaining the operation of the multiplier unit shown in FIG. 3;

FIG. 9 is a view useful in explaining the operation of the determination unit shown in FIG. 3;

FIG. 10 is a view useful in explaining the repetitiveness of lighting pattern data;

FIG. 11 is a view useful in explaining how to deal with a lighting pattern at an end of the display region;

FIG. 12 is a view useful in explaining how a method of the embodiment is applied to an edge-light type apparatus in which light sources are arranged along upper and lower sides of the display region;

FIG. 13 is a view illustrating the display region, the small regions and the light sources employed in the edge-light type apparatus of FIG. 12;

FIG. 14 is a view illustrating an example of a luminance distribution in the edge-light type apparatus of FIG. 12;

FIG. 15 is a view illustrating a typical display example in a conventional image display;

FIG. 16 is a view illustrating a display example in an image display according to the embodiments;

FIG. 17 is a block diagram illustrating the signal correction unit 102 shown in FIG. 1;

FIG. 18 is a view illustrating a luminance distribution example of light sources included in the backlight shown in FIG. 1;

FIG. 19 is a block diagram illustrating the liquid crystal panel shown in FIG. 1;

FIG. 20 is a block diagram illustrating an emission intensity calculation unit according to a third embodiment;

FIG. 21 is a block diagram illustrating an emission intensity calculation unit according to a fourth embodiment; and

FIG. 22 is a view useful in explaining the operation of the combining unit shown in FIG. 21.

### DETAILED DESCRIPTION

In one embodiment, an image display apparatus is disclosed. The apparatus includes a liquid crystal panel unit, a backlight unit, a calculation unit, a reference unit, a multiplier unit, and a determination unit. The liquid crystal panel unit displays a video image in a display region. The backlight unit includes a plurality of light sources illuminating the liquid crystal panel unit, the light sources is configured to illuminate illumination regions into which the display region is tentatively divided. The calculation unit calculates a representative value of relative luminances of pixels in the each of small regions into which the display region is divided, the small regions being smaller than the illumination regions. The reference unit refers to prestored lighting pattern data items for the light sources, and select a referred light pattern data item in accordance with a position of each of the small regions in the display region. The multiplier unit multiplies, for the each of the small regions, the referred lighting pattern data item by the representative value. The determination unit determines emission intensities of respective light sources based on multiplication results of the multiplier unit.

Image display apparatuses and information processing apparatuses according to embodiments will be described in detail with reference to the accompanying drawings. In the embodiments, like reference numbers denote like elements, and duplication of descriptions will be avoided.

The embodiments described hereinafter have been developed in consideration of the above problem, and aim to provide an image display apparatus and an information processing apparatus capable of displaying an object with a desired brightness regardless of the position on the display panel.

### First Embodiment

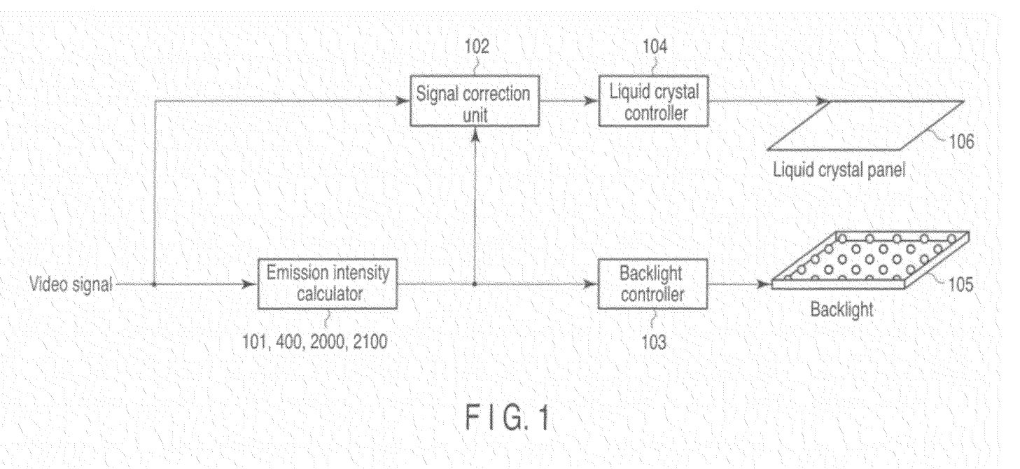

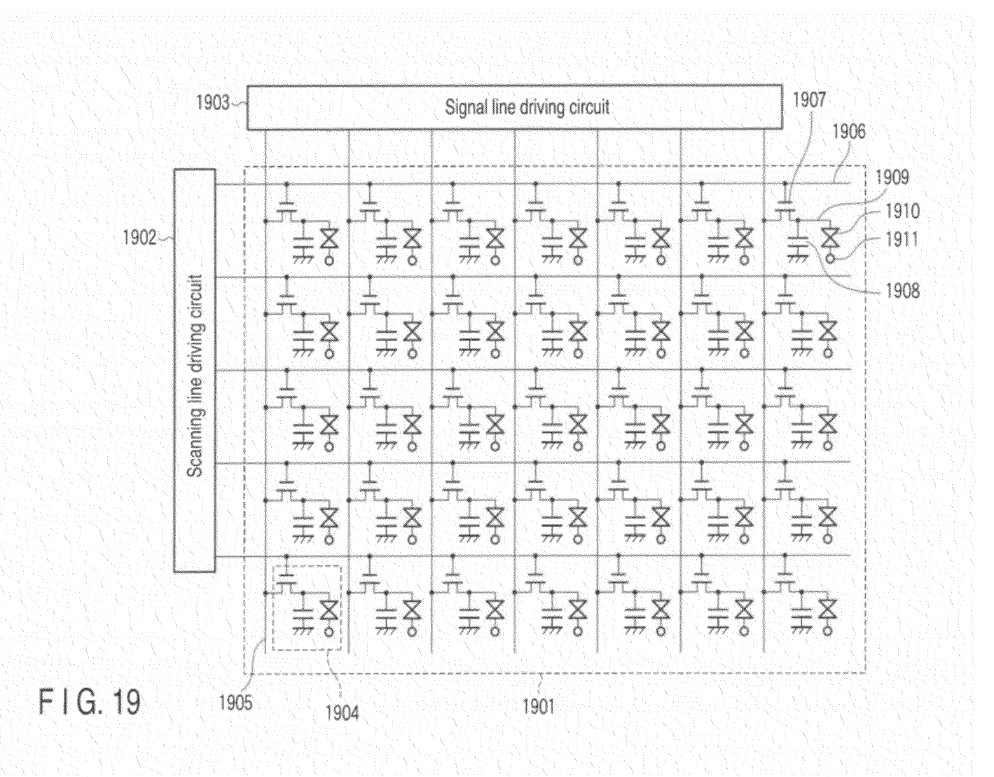

Referring to FIGS. 1 to 19, an image display according to a first embodiment is described.

<Image Display Apparatus>

Referring first to FIG. 1, the image display according to the first embodiment will be described. This image display comprises an emission intensity calculation unit 101, a signal correction unit 102, a backlight controller 103, a backlight 105, a liquid crystal controller 104, and a liquid crystal panel 106 with a plurality of pixels arranged in a matrix. The emission intensity calculation unit 101 will be also referred to as an information processing unit.

The emission intensity calculation unit 101 calculates the emission intensity of the backlight 105 suitable for display based on a one-frame video signal.

The signal correction unit 102 corrects the luminance (light transmittance) of each pixel indicated by the video signal, based on the calculated emission intensity of the backlight 105, and outputs the corrected video signal to the liquid crystal controller 104.

The backlight controller 103 controls lighting (emission) of the backlight 105 in accordance with the emission intensity calculated by the emission intensity calculation unit 101.

The backlight 105 is lit under the control of the backlight controller 103.

The liquid crystal controller 104 controls the liquid crystal panel 106 based on the video signal corrected by the signal correction unit 102.

The liquid crystal panel 106 receives light from backlight 105, and varies the amount of light passing therethrough under the control of the liquid crystal controller 104. Namely, the liquid crystal panel 106 modulates the light emitted by the backlight 105, thereby realizing image display.

The structure and operation of each element will be described in detail.

<Backlight>

The backlight 105 includes a plurality of light sources. These light sources are lit with respective intensities under the control of the backlight controller 103 to light up the liquid crystal panel 106 from behind.

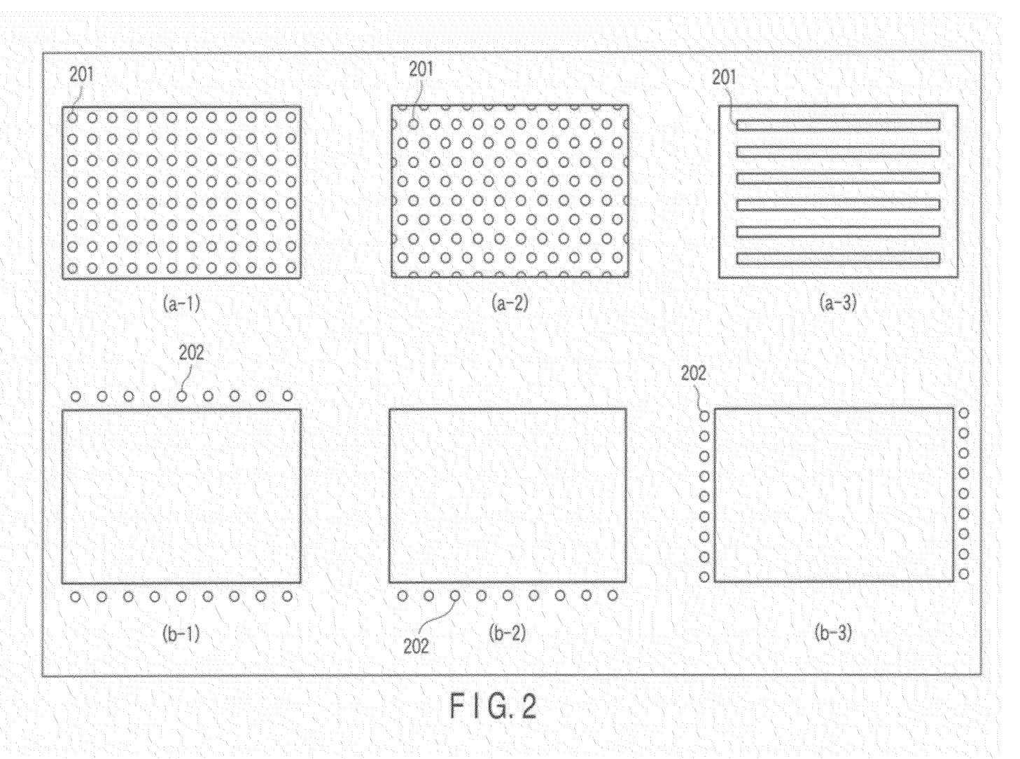

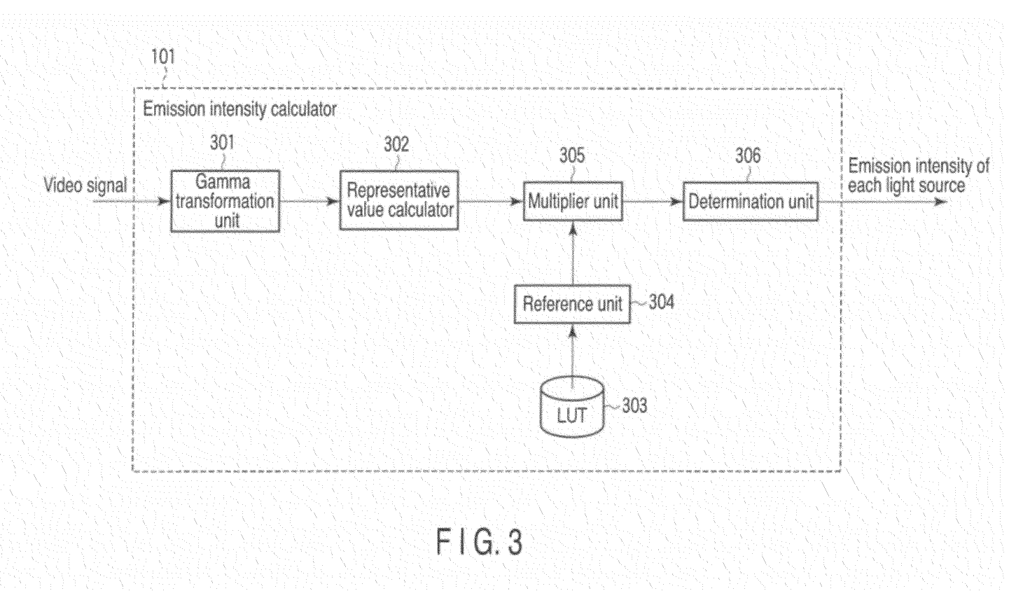

FIG. 2(a-1), FIG. 2(a-2), FIG. 2(a-3), FIG. 2(b-1), FIG. 2(b-2) and FIG. 2(b-3) show examples of the backlight 105. As shown in these figures, the backlight 105 has at least one light source 201 or 202. The light source(s) 201 may be provided directly behind the liquid crystal panel 106 as shown in FIG. 2(a-1), FIG. 2(a-2) and FIG. 2(a-3). Alternatively, an edge light type may be employed, in which the light source(s) 202 is provided along a side (sides) of the liquid crystal panel 106, and the light emitted therefrom is guided to the rear surface of the panel 106 by a light guide plate (not shown) or a reflector (not shown), as is shown in FIG. 2(b-1), FIG. 2(b-2) and FIG. 2(b-3).

Although from FIG. 2, each light source 201 or 202 seems to be formed of a single light emission element, it may be formed of a single light emission element, or may be formed of a plurality of light emission elements arranged along a plane parallel to the liquid crystal panel 106.

An LED, a cold cathode tube, a hot cathode tube, etc. are suitable for the light emission element. In particular, the LED is most preferable as the light emission element since the range between its maximum luminance and its minimum luminance is wide, and its emission can be controlled with high dynamic range. The emission intensity (luminance) and the emission timing of each light source 201, 202 can be controlled by the backlight controller 103.

<Backlight Controller>

The backlight controller 103 controls the intensity of each light source of the backlight 105 based on the corresponding emission intensity calculated by the emission intensity calculation unit 101. The backlight controller 103 can independently control the emission intensity (luminance) and the emission timing of each light source of the backlight 105.

<Emission Intensity Calculation Unit>

The emission intensity calculation unit 101 calculates the emission intensity of each light source suitable for display, based on a video signal. Referring now to FIG. 3, the emission intensity calculation unit 101 will be described.

The emission intensity calculation unit 101 comprises a gamma transformation unit 301, a representative value calculation unit 302, a lookup table (LUT) 303, a reference unit 304, a multiplier unit 305 and a determination unit 306.

The gamma transformation unit 301 transforms an input video signal into a relative luminance using gamma transformation. Assuming that the video signal falls within a range of [0, 255], the gamma transformation is given by, for example, the following equation (1):

L=(S/255)^{γ} (1)

where S is a signal value, and L is a relative luminance. Further, it is desirable that γ correspond to the gamma value of the liquid crystal panel 106, and is set to about 2.2. The transformation may be directly executed using, for example, a multiplier. Alternatively, it may be executed using the lookup table.

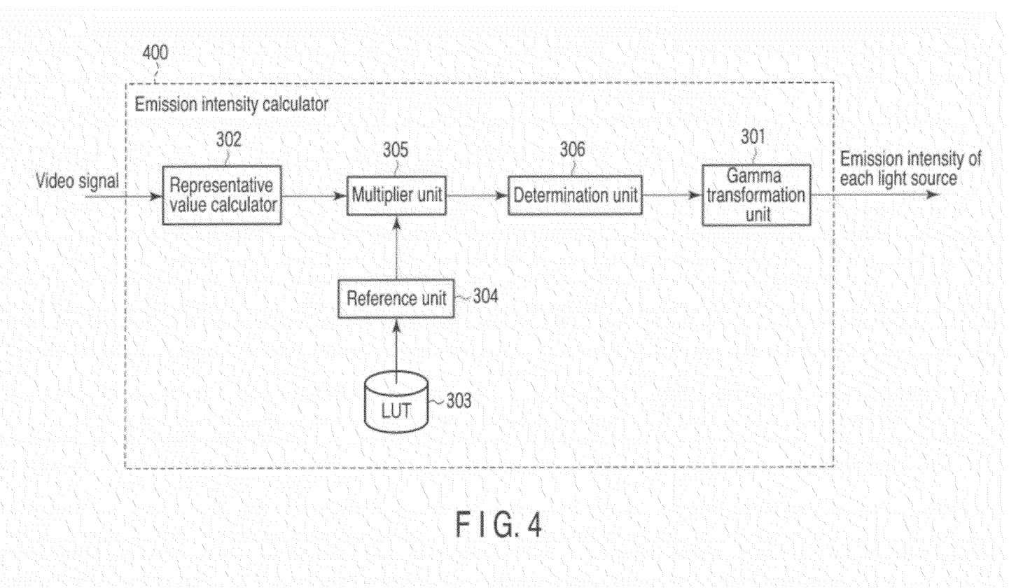

The emission intensity calculation unit 101 may be modified such that the gamma transformation unit 301 is provided after the determination unit 306 as shown in FIG. 4. In this case, the gamma transformation unit 301 of an emission intensity calculation unit 400 executes the same transformation as given by the equation (1) on the emission intensity of each light source calculated by the determination unit 306, and the resultant signal is used as the output of the emission intensity calculation unit 400.

It is not always necessary to include the gamma transformation unit 301 in the emission intensity calculation unit 101 or 400. The gamma transformation unit 301 may be provided outside (i.e., before or after) the emission intensity calculation unit 101 or 400.

The representative value calculation unit 302 calculates the representative value of the relative luminances of a plurality of pixels contained in each of small regions into which each of the divisions of a display region that correspond to the illumination regions of the light sources is further divided. The representative value is, for example, a maximum value. Other representative values that can be calculated by the representative value calculation unit 302 are, for example, a value obtained by multiplying by a constant value the mean value of the relative luminances of the pixels contained in each small region, a value obtained by multiplying by a constant value the mean value of the maximum and minimum values of the relative luminances of the pixels contained in each small region, and a value obtained by a calculation method that is a combination of those calculation methods.

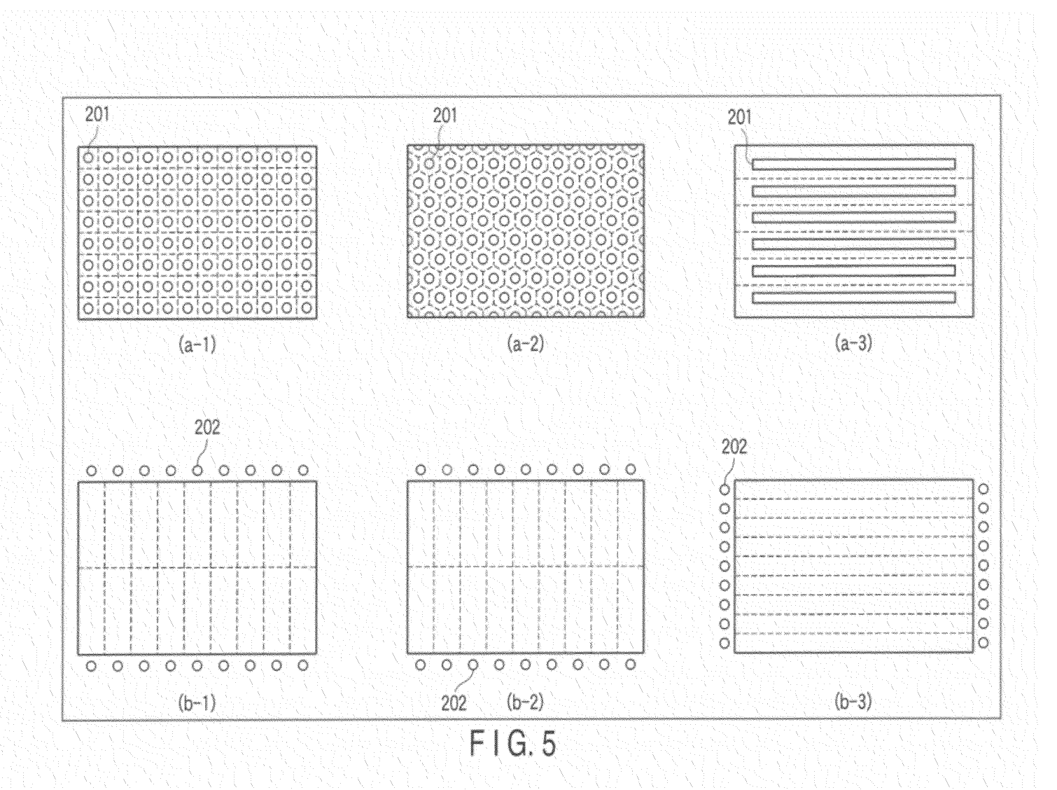

FIG. 5 shows, using the broken lines, examples of arrangements of the divisions of the display region corresponding to the illumination regions of the light sources. FIG. 5(a-1), FIG. 5(a-2), FIG. 5(a-3), FIG. 5(b-1), FIG. 5(b-2) and FIG. 5(b-3) show arrangement examples of display region divisions corresponding to the illumination region arrangements of the backlight structures shown in FIG. 2(a-1), FIG. 2(a-2), FIG. 2(a-3), FIG. 2(b-1), FIG. 2(b-2) and FIG. 2(b-3), respectively.

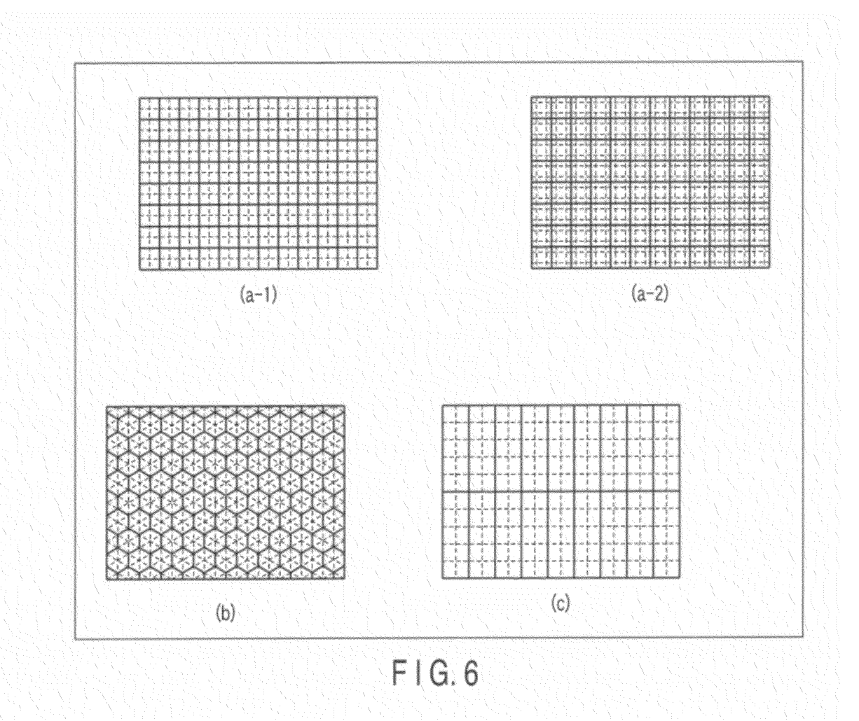

FIG. 6 shows arrangement examples of display region divisions employed in the first embodiment. In FIG. 6, the solid lines indicate the arrangements of the display region divisions corresponding to the illumination region arrangements of the light sources, and the solid lines and the broken lines indicate arrangement examples of small regions into which the display region divisions are further divided.

FIG. 6(a-1) shows an example in which the divisions of the display region corresponding to FIG. 5(a-1) are further divided into small regions. In FIG. 6(a-1), the solid lines indicate the divisions of the display region corresponding to the illumination regions of the light sources, and the solid lines and the broken lines indicate an arrangement example of small regions into which the divisions of the display region are further divided. More specifically, FIG. 6(a-1) shows an arrangement example in which the divisions of the display region corresponding to the illumination regions shown in FIG. 5(a-1) are further divided into small regions with a horizontally and vertically double density with respect to the divisions.

FIG. 6(a-2) shows another example in which the divisions of the display region corresponding to the illumination regions shown in FIG. 5(a-1) are further divided into small regions in another way. In FIG. 6(a-2), the solid lines indicate the divisions of the display region corresponding to the illumination regions of the light sources, and the broken lines indicate an example of an arrangement of small regions into which the divisions of the display region are further divided. Also in FIG. 6(a-2), the divisions of the display region corresponding to the illumination regions shown in FIG. 5(a-1) are further divided into small regions with a horizontally and vertically double density with respect to the divisions of the display region. As is evident from FIG. 6(a-2), the pattern of dividing the display region into small regions is not limited to that shown in FIG. 6(a-1).

FIG. 6(b) shows an example in which the divisions of the display region corresponding to the illumination regions shown in FIG. 5(a-2) are further divided into small regions. In FIG. 6(b), the solid lines indicate the divisions of the display region corresponding to the illumination regions of the light sources, and the solid lines and the broken lines indicate an arrangement example of small regions into which the divisions of the display region are further divided. Although in the example of FIG. 6(a-1), the divisions of the display region corresponding to the illumination regions are further divided into small regions with a horizontally and vertically m-times density (m: integer) with respect to the divisions, the pattern of dividing the display region into small regions is not limited to this, as is evident also from FIG. 6(b).

FIG. 6(c) shows an example in which the divisions of the display region corresponding to the illumination regions shown in FIG. 5(b-1) are further divided into small regions. In FIG. 6(c), the solid lines indicate the divisions of the display region corresponding to the illumination regions of the light sources, and the solid lines and the broken lines indicate an arrangement example of small regions into which the divisions of the display region are further divided. Although in the example of FIG. 6(a-1), the divisions of the display region are further divided into small regions with a horizontally and vertically m-times density (m: integer) with respect to the divisions, the pattern of dividing the display regions into small regions is not limited to this, as is evident also from FIG. 6(c).

The representative value calculation unit 302 calculates the representative value of the relative luminances of a plurality of pixels contained in a space corresponding to each small region. It is sufficient if the space as a representative value calculation target substantially corresponds to each small region. Namely, the space may be slightly larger or smaller than each small region. A slight change in the space does not adversely affect the main advantage of the embodiment.

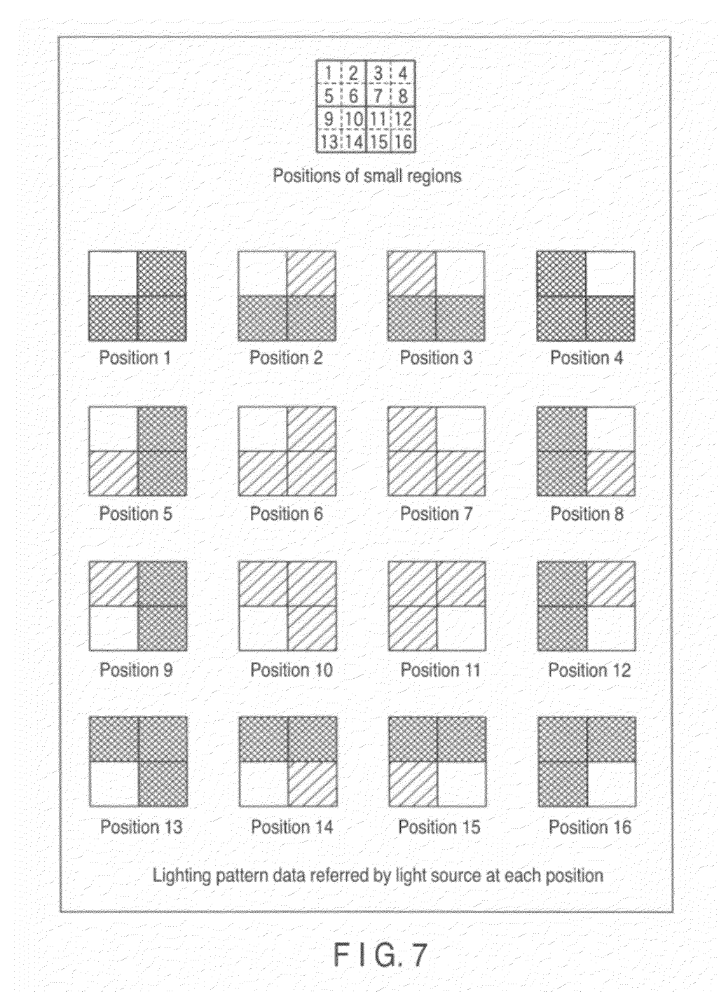

The reference unit 304 refers to prestored lighting pattern data for each small region in accordance with the position of said each small region. The stored lighting pattern data items indicate the emission intensities to which each light source should refer in association with each small region. Referring now to FIG. 7, the operation of the reference unit 304 will be described.

In FIG. 7, the solid lines indicate the divisions of the display region corresponding to the illumination regions of the light sources, and the broken lines indicate small regions into which the divisions of the display region are further divided. The reference unit 304 refers, for each small region, to prestored lighting pattern data items of the light sources corresponding to the position of said each small region. For instance, for small region “1” shown in the upper part of FIG. 7, the reference unit 305 refers to the lighting pattern data item corresponding to “position 1” in the lower part of FIG. 7. For the other small regions, the lighting pattern data items corresponding to their positions are referred to. In the example of FIG. 7, the LUT 303 holds lighting pattern data items corresponding to sixteen positions. In FIG. 7, for convenience sake, the emission intensities of each light source are indicated by variations in hatching density in the small regions corresponding thereto.

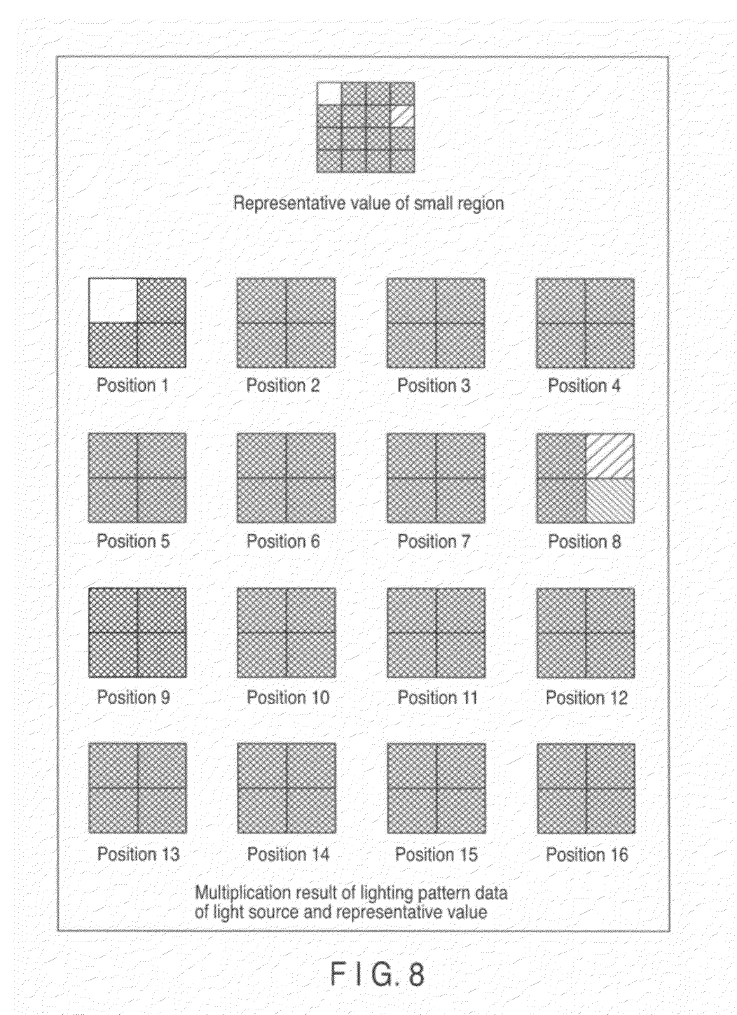

The multiplier unit 305 multiplies each value of each lighting pattern data item, referred to by the reference unit 304 in accordance with the position of each small region, by the representative value in said each small region calculated by the representative value calculation unit 302. Referring to FIG. 8, an operation example of the multiplier unit 305 will be described.

In the operation example of FIG. 8, since the representative value calculated by the representative value calculation unit 302 for the small region at position “1” is high, a relatively high luminance is acquired for this small region from the multiplication of the aforementioned value of each lighting pattern data item and the calculated representative value. In contrast, since the representative value calculated by the representative value calculation unit 302 for the small region at position “2” is low, the result of multiplication of the value of each lighting pattern data item referred to in accordance with position “2” and the representative value of the small region at position “2” indicates substantially a low luminance. Similarly, since the representative value calculated by the representative value calculation unit 302 for the small region at position “8” is an intermediate value, the result of multiplication of the value of each lighting pattern data item referred to in accordance with position “8” and the representative value of the small area at position “8” indicates a slightly lower luminance than the initially referred value of said each lighting pattern data item. In FIG. 8, for convenience sake, the multiplication results of each light source are indicated by variations in hatching density in the small regions corresponding to said each light source, as in FIG. 7.

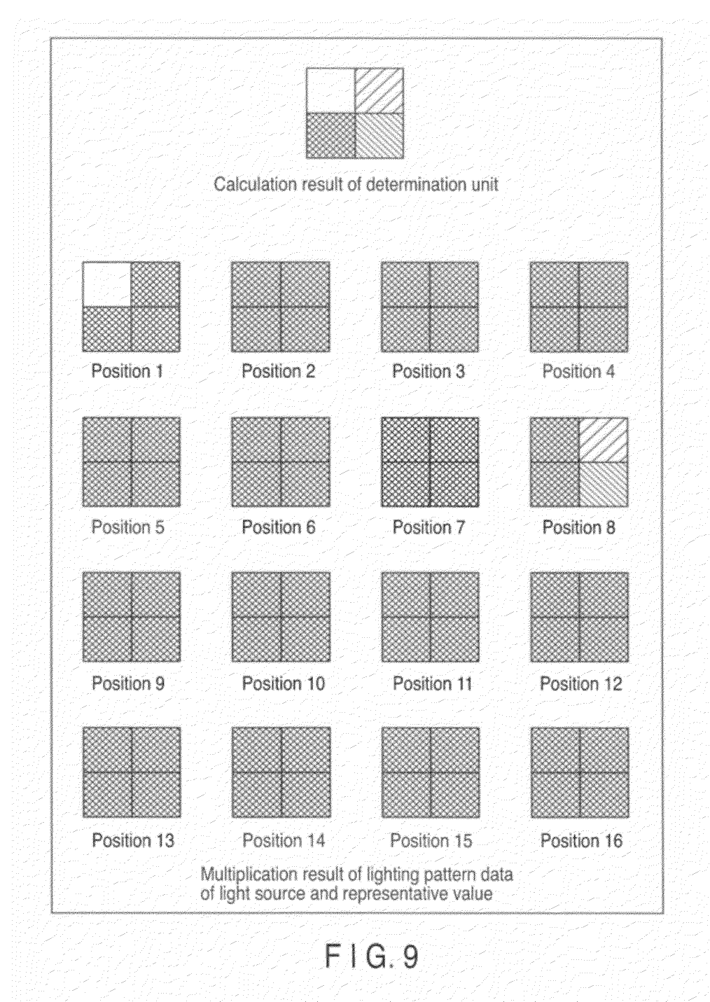

Based on the multiplication results of each light source calculated by the multiplier unit 305 for each small region, the determination unit 306 determines the emission intensity of said each light source. Referring to FIG. 9, the operation of the determination unit 306 will be described. FIG. 9 shows an operation example in which the maximum value of the multiplication results of each light source calculated by the multiplier unit 305 for each small region is determined to be the emission intensity of said each light source. As shown in FIG. 9, the determination unit 306 determines that the maximum value of the multiplication results of each light source calculated by the multiplier unit 305 for each small region is the emission intensity of said each light source. More specifically, in the upper left region, the maximum value at positions 1 to 16 is “white,” and hence “white” is determined to be the maximum value. Similarly, in the right upper region, the maximum value at positions 1 to 16 is “thin gray (thin hatching),” and hence “thin gray” is determined to be the maximum value. Regarding the lower left and lower right regions, positions 1 to 16 are all in black, and hence “black” is determined to be the maximum value. In FIG. 9, the multiplication results and emission intensities corresponding to each light source are indicated by variations in hatching density in the small regions corresponding to each light source, for convenience sake.

The above-described operations of the reference unit 304, the multiplier unit 305 and the determination unit 306 can be expressed by the following equation (2):

$${L}_{S} ( i ) = {max}_{j = 1}^{N} ( {L}_{R} ( j ) \cdot {L}_{P} ( i , j ) ) \qquad ( 2 )$$

where i is an index for identifying the light source, and j is an index for indentifying the small region, j being an integer falling within a range of 1 to N (N is the total number of small regions). Further, L_{R}(j) is the representative value calculated by the representative value calculation unit 302 and corresponding to the j^{th} small region, L_{P}(i, j) is the value of the lighting pattern data referred to by the reference unit 304 for the j^{th} small region and corresponding to the i^{th} light source, and Ls(i) is the emission intensity of the i^{th} light source. The following expression (2-1) indicates the maximum value of the parenthesized values within a range of j=1-N.

$${max}_{j = 1}^{N} ( ) \qquad ( 2 \text{-} 1 )$$

Regarding the determination of the emission intensities of each light source by the determination unit 306, the processing result of the multiplier unit 305 may be temporarily stored whenever one small region is processed, and the maximum emission intensity of each light source be determined after all small regions are processed. Alternatively, whenever one small region is processed, the result of the process may be compared with the maximum emission intensity of each light source calculated so far, thereby temporarily storing the higher value in a memory.

As described above, the emission intensity calculation unit 101 calculates the emission intensity of each light source based on a video signal and prestored lighting pattern data.

### <Modification of Emission Intensity Calculation Unit 101>

In the above-described structure, the lighting patterns of all light sources are stored for each small region of each division of the display region, and are referred to. However, this structure may be modified when necessary, as follows:

### <<Use of Repetitive Pattern of Lighting Pattern Data>>

For example, if the illumination regions in the display region are arranged in a repetitive pattern, and the illumination region of each light source is not so large, the memory size necessary to hold the lighting pattern and the number of times of reference to the lighting pattern can be reduced, using those characteristics.

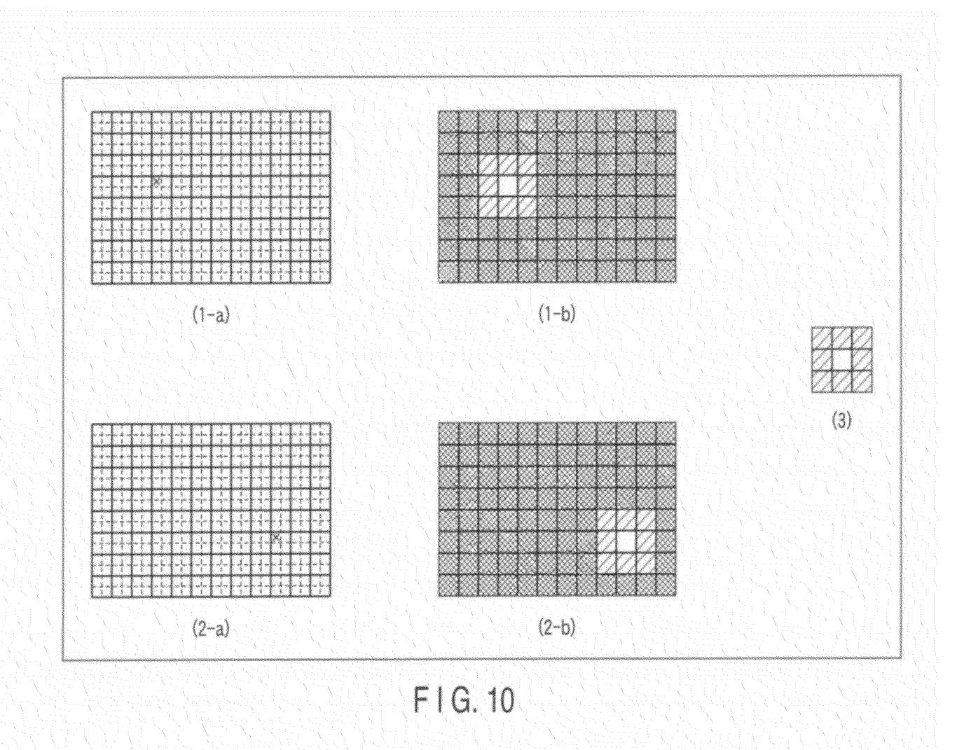

This will be explained with reference to FIG. 10. FIG. 10(1-b) and FIG. 10(2-b) show lighting pattern data examples corresponding to the small regions indicated by mark X in FIG. 10(1-a) and FIG. 10(2-a), respectively. Assume that the black regions in FIG. 10(1-b) and FIG. 10(2-b) have a low lighting pattern data value that can be ignored. As is evident from these figures, the lighting pattern of FIG. 10(1-b) and that of FIG. 10(2-b) can be regarded as substantially the same lighting pattern, if the position of the illumination region of each light source is expressed as a position relative to a corresponding small region. In this case, if the position of the illumination region of each light source is identified as a position relative to a corresponding small region, such lighting pattern data as shown in FIG. 10(3) can be used in place of the lighting pattern data corresponding to the small regions indicated by mark X in FIG. 10(1-a) and FIG. 10(2-a). This replacement can be realized by executing appropriate coordinate transform when the reference unit 304 refers to the lighting pattern data.

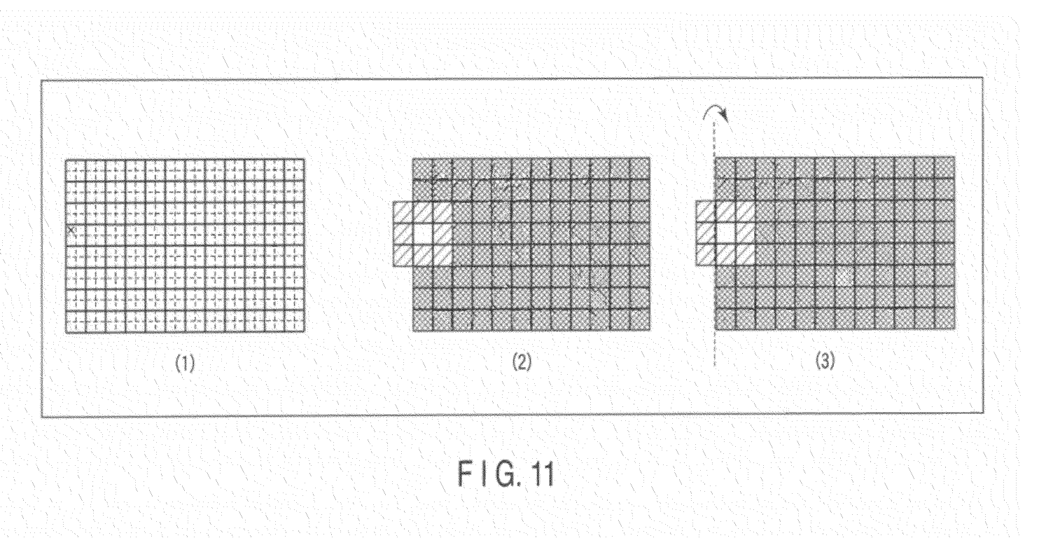

When the reference unit 304 is constructed to execute the above-mentioned coordinate transform, a to-be-referred lighting pattern corresponding to a target small region located at an end of the display region may fall outside the display region as shown in FIG. 11(1). In this case, an imaginary illumination region is provided as shown in FIG. 11(2), and a lighting pattern referred to for the imaginary illumination region can be applied to a light source corresponding to an illumination region that is superposed with the imaginary illumination region when the imaginary illumination region is folded along the end of the display region, as is shown in FIG. 11(3). For the portion of the lighting pattern on which the folded lighting pattern is superposed, the reference unit 304 refers to both the lighting patterns. For instance, the reference unit 304 refers, as a new lighting pattern, to a pattern obtained by selecting the portions of the two superposed patterns that are higher in emission intensity. In the case of FIG. 11(3), a lighting pattern formed of gray, white and gray portions is referred to for a vertical portion of the target small region.

### <<Use of Symmetry of Patterns for Small Region>>

In FIG. 7, lighting pattern data corresponding to a small region “6” and that corresponding to a small region “7” are symmetrical. This is because the small region “6” is at the lower right position with respect to the nearest illumination region, and the small region “7” is at the lower left position with respect to the nearest illumination region, which means that these small regions are arranged symmetrical with respect to the illumination region. In this case, only one of these symmetrical lighting patterns is stored, and when the reference unit 304 refers to the lighting pattern data, the right and left portions of the illumination region of each light source are reversed. This can reduce the memory size necessary for the lighting pattern data. The same can be realized regarding vertical symmetry.

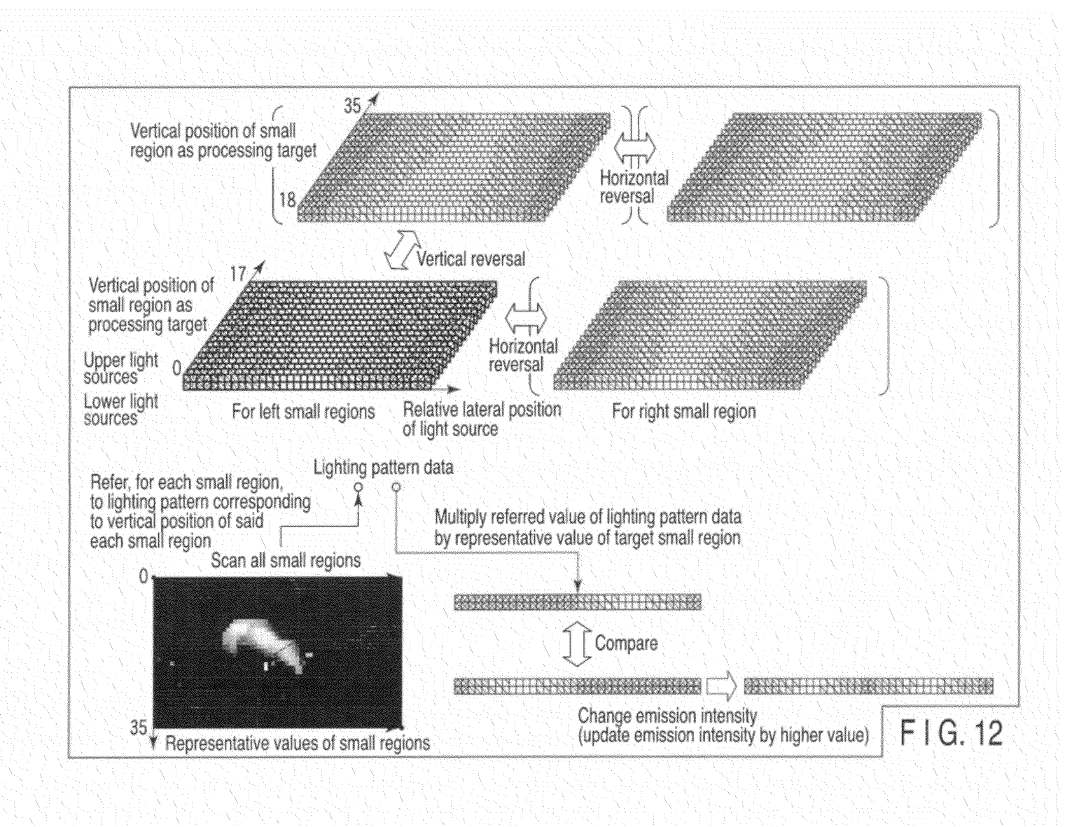

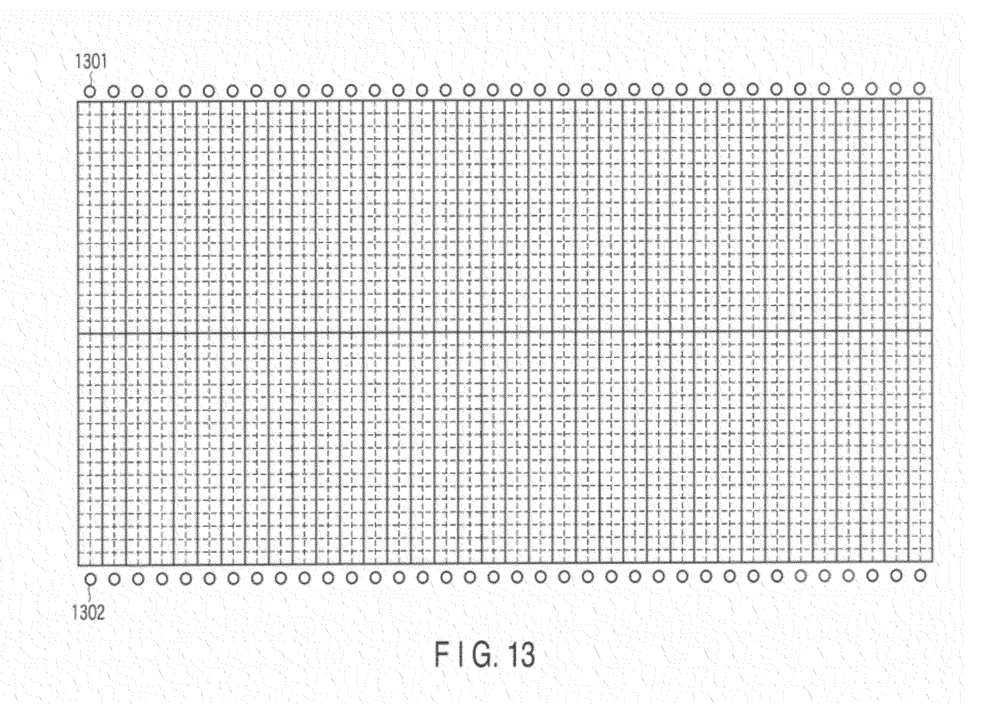

FIG. 12 schematically shows a structure example obtained by applying the reference unit 304, the multiplier unit 305 and the determination unit 306 constructed as the above, to such an edge-light type image display as shown in FIG. 2(b-1). More specifically, FIG. 12 shows a structure example of an edge-light type image display with a display region that incorporates 36 light sources provided along each of the upper and lower edges thereof. Further, in this structure example, the display region is assumed to be divided into small regions of 72×36. FIG. 13 shows this display region and the light sources provided at the upper and lower sides of the display region (i.e., upper light sources 1301 and lower light sources 1302).

Firstly, the reference unit 304 refers to the lighting pattern data prestored for each small region. The LUT 303 holds the lighting pattern data. As the lighting pattern data, pairs of pattern data items dedicated to light sources for the upper portion of the display region, and dedicated to light sources for the lower portion of the display region, are prepared, which include different data items set for small regions at different vertical positions in the display region. Further, the lighting pattern data corresponds to the lateral position of each light source relative to each small region. This structure enables the memory size necessary to hold the lighting pattern data to be reduced as mentioned above. Furthermore, in the example of FIG. 12, symmetry of division of the display region into the small regions is utilized to further reduce the memory size necessary to hold the lighting pattern data. Specifically, in FIG. 12, the three bracketed [ ] lighting pattern data items are virtual lighting pattern data items that do not require a memory. These virtual data items are acquired by executing appropriate coordinate transformation of the lighting pattern data for “left small regions” in the reference unit 304.

Also in FIG. 12, the “left small region” means the region positioned on the left side of a closest illumination region. The same can be said of “right small regions.” For instance, for the N^{th} small region from above, which is positioned on the left side of a closest illumination region, the lighting data item, which is included in the lighting pattern data for the left small regions and corresponds to the vertical position N of the “target small region,” is referred to.

In FIG. 12, it is highly important that in, for example, such an edge-light type image display as shown in FIG. 2(b-1), different lateral lighting patterns can be realized for different vertical positions of small regions.

For a small region, the multiplier unit 305 multiplies the value of the lighting pattern data, which is referred to by the reference unit 304 in accordance with the position of the small region, by the representative value calculated by the representative value calculation unit 302 and corresponding to the small region.

Whenever the multiplier unit 305 finishes processing of a small region, the determination unit 306 compares the emission intensity of each light source as the processing result thereof in the small region with the maximum emission intensity of said each light source calculated so far in the small region, and updates the value of a temporary memory by the higher value as the comparison result. Thus, the maximum value of the processing results obtained by the multiplier unit 305 is stored as the maximum emission intensity of said each light source in the small region.

As can be understood from FIG. 12, in the first embodiment, the lighting patterns of each light source can be stored and referred to in accordance with the positions of the small regions. Namely, in the first embodiment, the lighting patterns of each light source, which differ at the different positions of the small regions, can be stored and referred to. As a result, the first embodiment can calculate an appropriate emission intensity of each light source for each small region.

<Operation and Advantage>

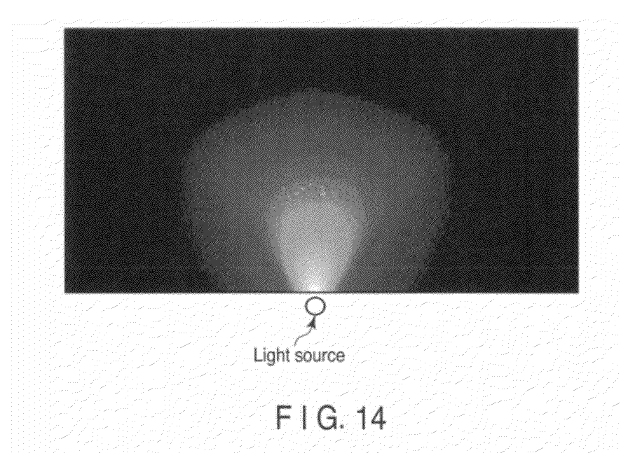

Referring to FIGS. 14, 15 and 16, the operation and advantage of the first embodiment will be described.

FIG. 14 shows an example of a luminance distribution of a single light source included in the backlight 105 of the edge-light type. As is also evident from FIG. 14, in, for example, the backlight of the edge-light type, the luminance distribution of a single light source is anisotropic. In the example of FIG. 14, the lateral luminance distribution width of the light source is small near the light source, and increases as the vertical distance of the luminance distribution increases.

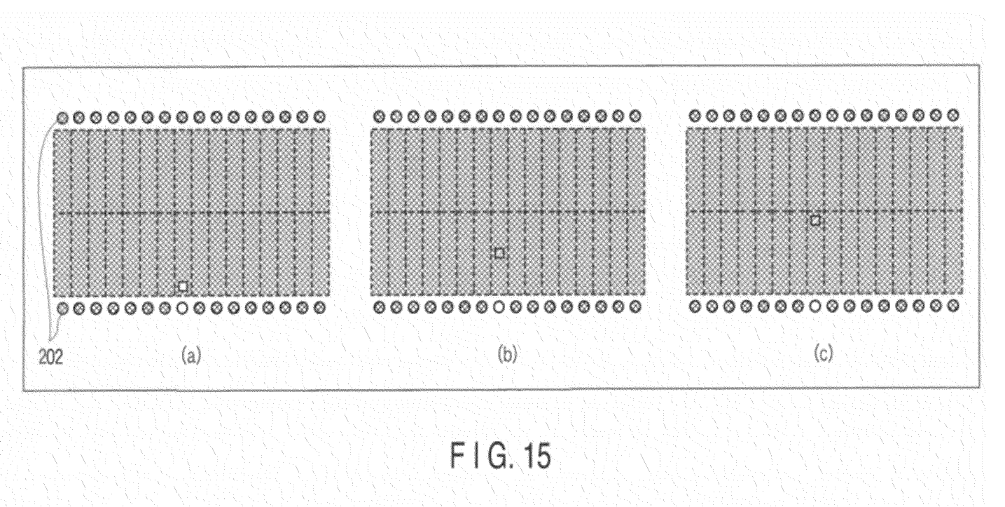

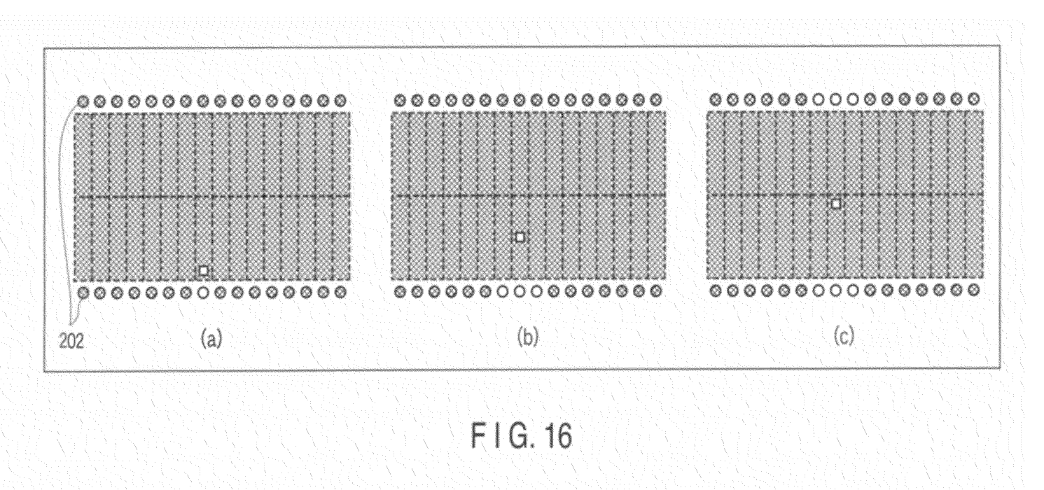

FIG. 15 shows a conventional typical display example of an image display in which each light source has a luminance distribution as shown in FIG. 14. In FIGS. 15 and 16, the broken lines indicate divisions of the display region corresponding to the illumination regions of the light sources. FIG. 15(a), FIG. 15(b) and FIG. 15(c) show states of a conventional image display, in which a white box of a predetermined brightness is displayed in a dark background, lit by a light source. Assume here that the white boxes shown in FIG. 15(a), FIG. 15(b) and FIG. 15(c) have the same brightness although they are positioned at different vertical positions.

In the conventional image display, since, for example, the representative value of an input video signal is calculated in a division corresponding to the illumination region of a light source and the luminance of the light source is determined based on the calculated value, the same lighting pattern is employed in FIG. 15(a), FIG. 15(b) and FIG. 15(c). In the case shown in, for example, FIG. 14 where the lateral luminance distribution width of a single light source is small near the light source, and increases as the vertical distance from the light source increases, the white box positioned near the light source as shown in FIG. 15(a) may be displayed sufficiently brightly, whereas the white box positioned far from the light source as shown in FIG. 15(c) may not be displayed sufficiently brightly. Namely, in the conventional image display where the luminance distribution of each light source is anisotropic as, for example, the edge-light type, a problem may occur in which the same object significantly differs in brightness between different positions on the screen of the display apparatus.

FIG. 16 shows states of the image display of the first embodiment, which are assumed when input video images similar to those of FIG. 15 are displayed. In the image display of the first embodiment, a representative value is calculated in each of the divisions (small regions), into which the divisions of the display region are further divided, and which are smaller than the illumination region of each light source. Further, when the luminances of light sources in each small region are calculated, different lighting patterns can be referred to in accordance with the relative positions of the illumination region of each light source and each small region. Accordingly, as shown in, for example, FIG. 16, when a bright object near the light sources is displayed, a small number of laterally arranged light sources (e.g., lower light sources) are lit, and when a bright object vertically a little far from the light sources is displayed, a larger number of laterally arranged light sources are lit. In addition, when a bright object vertically farther from the light sources is displayed, a number of oppositely arranged light sources (e.g., upper light sources) are lit. Thus, in accordance with the position of a target object in a division corresponding to the illumination region of each light source, the lighting pattern of the light sources can be changed. This structure enables changes in the brightness of a bright object between different display positions to be minimized, as is shown in FIG. 16.

<Signal Correction Unit>

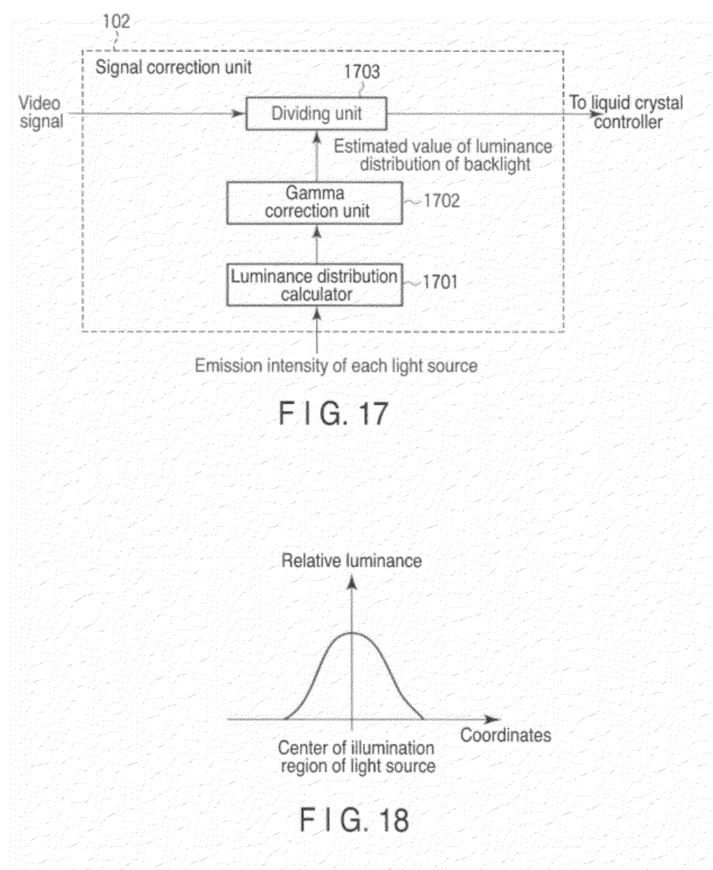

The signal correction unit 102 corrects a video signal for each pixel of the liquid crystal panel 106 based on the emission intensity of each light source calculated by the emission intensity calculation unit 101 and an input video signal, and outputs the corrected signal to the liquid crystal controller 104. FIG. 17 shows a structure example of the signal correction unit 102.

As shown, the signal correction unit 102 comprises a luminance distribution calculation unit 1701, a gamma correction unit 1702, and a dividing unit 1703.

The luminance distribution calculation unit 1701 calculates predicted values for the luminance distribution of light entering the liquid crystal panel 106 when the light sources are lit with the respective emission intensities calculated by the emission intensity calculation unit 101.

The light entering the liquid crystal panel 106 when the light sources are lit has an emission distribution corresponding to the actual hardware structure of the light sources of the backlight 105, since the light sources each have an emission distribution corresponding to the hardware structure. The intensity of the light entering the liquid crystal panel 106 will hereinafter be referred to simply as the luminance of the backlight 105 or that of the light sources. FIG. 18 shows a luminance distribution example of each light source. This luminance distribution example is symmetrical with respect to the center of the illumination region of each light source, the luminance decreasing as the position is away from the center of the illumination region. The luminance, obtained at each position (which is expressed by coordinates) when the n^{th} light source is lit with an emission intensity L_{SET,n}, is given using the luminance distribution, as follows:

L_{BL}(x′ₙ,y′ₙ)=L_{SET,n}·L_{P,n}(x′ₙ,y′ₙ) (3)

where x′ₙ and y′ₙ are relative coordinates of each position with respect to the center of the illumination region of the n^{th} light source, and L_{P,n} is the luminance of the n^{th} light source at the relative coordinates.

The luminance at each pixel position, assumed when each light source of the backlight 105 is lit with the emission intensity L_{SET,n}, is calculated as the sum of the values obtained by multiplying the luminance of each light source corresponding to said each pixel position by the emission intensity of said each light source.

Namely, the luminance distribution L_{BL}(x, y) of the backlight 105 is given by the following equation (4), using the luminance distribution data L_{P,n} corresponding to each light source:

$${L}_{BL} ( x , y ) = {\sum }_{n = 1}^{N} \{ {L}_{SET , n} \cdot {L}_{P , n} ( x - {x}_{0 , n} , y - {y}_{0 , n} ) \} \qquad ( 4 )$$

where x and y are the coordinates of each pixel on the liquid crystal panel 106, X_{0,n} and Y_{0,n} are the coordinates of the center of the illumination region of the n^{th} light source on the liquid crystal panel 106, and N is the total number of the light sources. In the equation (4), when acquiring the luminance of the backlight 105 at a target pixel, the emission intensities and luminance distributions of all light sources are used. However, the emission intensities and luminance distributions of the light sources that do not significantly influence the luminance of the target pixel can be eliminated when the luminance of the target pixel is calculated.

The luminance distribution of each light source may be directly calculated by approximation using an appropriate function, or be calculated using a prepared lookup table.

The gamma correction unit 1702 executes gamma correction on the predicted value calculated for luminance distribution by the luminance distribution calculation unit 1701, and converts the resultant value into a signal correction coefficient. Supposing that the output signal correction coefficient falls within a range of [0, 1], the gamma correction is executed using, for example, the following equation:

S_{BL}=L_{BL}^{1/γ} (5)

where L_{BL} is the predicted value calculated for luminance distribution by the luminance distribution calculation unit 1701, and S_{BL} is the signal correction coefficient. The gamma correction is not limited to this transformation, but may be replaced with a known transformation method, or inverse transformation based on the gamma transformation table of the liquid crystal panel 106, when necessary. These transformations may be directly executed using, for example, a multiplier, or be executed using a lookup table.

The dividing unit 1703 divides the input video signal by the signal correction coefficient calculated by the gamma correction unit 1702, thereby calculating a video signal output to the liquid crystal controller 104. Alternatively, the dividing unit 1703 may hold a lookup table that stores the relationship between values corresponding to inputs and outputs, and may calculate the video signal output to the liquid crystal controller 104 with reference to the lookup table.

### <Liquid Crystal Panel and Liquid Crystal Controller>

In the first embodiment, the liquid crystal panel 106 is of an active matrix type. In the panel, a plurality of signal lines 1905 and a plurality of scanning lines 1906 intersecting the signal lines are provided on an array substrate 1901 with an insulating film (not shown) interposed therebetween, and pixels 1904 are provided at the intersections of those lines. Ends of the signals 1905 and ends of the scanning lines 1906 are connected to a signal line driving circuit 1903 and a scanning line driving circuit 1902, respectively. Each pixel 1904 comprises a switch element 1907 formed of a thin-film transistor (TFT), a pixel electrode 1909, a liquid crystal layer 1910, an auxiliary capacitor 1908, and a counter electrode 1911. The counter electrode 1911 is connected in common to all pixels.

The switch element 1907 is provided for video signal writing, and has its gate connected to one of the scanning line 1906, and its source connected to one of the signal lines 1905. More specifically, the gates of the switch elements arranged in each row are connected in common to the one scanning line 1906, and the sources of the switch elements arranged in each row are connected in common to the one signal line 1905. Further, the drain of each switch element 1907 is connected to the pixel electrode 1909 of the same and also to the auxiliary capacitor 1908 of the same arranged electrically parallel to the pixel electrode 1909.

The pixel electrode 1909 is formed on the array substrate 1901, and the counter electrode 1911 electrically opposite to the pixel electrode 1909 is formed on a counter substrate (not shown). A predetermined counter voltage is applied to the counter electrode 1911 by a counter voltage generation circuit (not shown). The liquid crystal layer 1910 is held between the pixel electrode 1909 and the counter electrode 1911, and the peripheral portions of the array substrate 1901 and the counter electrode 1911 are sealed by a seal member (not shown). Any liquid crystal material may be used for the liquid crystal layer 1910. However, ferroelectric liquid crystal, liquid crystal of an optically compensated bend mode (OCB), etc., are preferable as the liquid crystal material.

The scanning line driving circuit 1902 comprises a shift register, a level shifter, a buffer circuit, etc. The scanning line driving circuit 1902 outputs a row selection signal to each scanning line based on a vertical start signal and/or a vertical clock signal, which are output as control signals from a display ratio controller (not shown).

The signal line driving circuit 1903 comprises an analog switch, a shift register, a sample hold circuit, a video bus, etc., which are not shown. The signal line driving circuit 1903 receives a horizontal start signal and a horizontal clock signal output as control signals from the display ratio controller.

The liquid crystal controller 104 controls the liquid crystal panel 106 to adjust its liquid crystal transmittance to that corrected by the signal correction unit 102.

In the first embodiment constructed as the above, a representative value is calculated in each of the small regions, into which small regions the divisions corresponding to the illumination regions of the light sources (into which the display region is divided) are further divided. Further, when the luminances of the light sources in a small region are calculated, different lighting patterns corresponding to the relative positions of the illumination regions of the light sources and the small region are referred to. This enables an object to be displayed with a small change in brightness wherever on the panel the object is displayed. Namely, in the first embodiment, an object can be displayed with a desired brightness at any position on the panel.

### Second Embodiment

An image display according to a second embodiment incorporates a backlight unit 105 that incorporates a plurality of backlights 105 having different emission colors (having different spectral characteristics). In the second embodiment, for each color of the backlights 105, the emission intensity calculation unit 101 calculates a representative value in each small region into which small regions the divisions of the display region corresponding to the illumination regions of the light sources are further divided. Further, when the luminances of the light sources in each small region are calculated, the lighting pattern data items are referred to, which are preset in accordance with the relative positions of the illumination regions of the light sources and each small region.

For instance, when the backlight unit 105 comprises three backlights 105 with emission colors of red (R), green (G) and blue (B), the emission intensity calculation unit 101 of the second embodiment perform the following processes for each of the emission colors: Namely, the input video signals corresponding to the three colors are each transformed by gamma transformation into relative luminances. The representative value calculation unit 302 calculates a representative value from the relative luminances of a plurality of pixels contained in each small region smaller than the divisions of the display region that correspond to the illumination regions of light sources. Subsequently, referring to the lighting pattern data of each light source prestored for each small region, the multiplier unit 305 multiplies, by the representative value calculated by the representative value calculation unit 302, each of the values of the lighting pattern data items of the light sources referred to by the reference unit 304 in accordance with the position of each small region, whereby the maximum value of the multiplication results calculated by the multiplier unit 305 for each small region is regarded as the emission intensity of each light source in each small region.

Further, if the colors of the backlights 105 differ from the color of the input video signal, the color of the input video signal is converted into a color corresponding to a combination of the emission colors of the backlights 105, and then the emission intensity calculation unit 101 may be operated as the above for the individual backlights 105 of the different colors.

In the above-described second embodiment, when a plurality of backlights 105 having different emission colors (having different spectral characteristics) are used, the same advantage as the first embodiment can be obtained by calculating, in association with each backlight 105, a representative value in each small region smaller than the divisions of the display region that correspond to the illumination regions of light sources, and referring to the lighting pattern data prestored for each small region in accordance with the position of each small region, when calculating the luminance of each light source in each small region.

### Third Embodiment

An information processing apparatus and an image display according to a third embodiment significantly differ from those of the first embodiment in that in the third embodiment, an emission intensity calculation unit 2000 holds a plurality of sets of predetermined lighting patterns, and includes a selection unit 2001. Since the other structure of the third embodiment is similar to that of the first embodiment, no detailed description is given thereof.

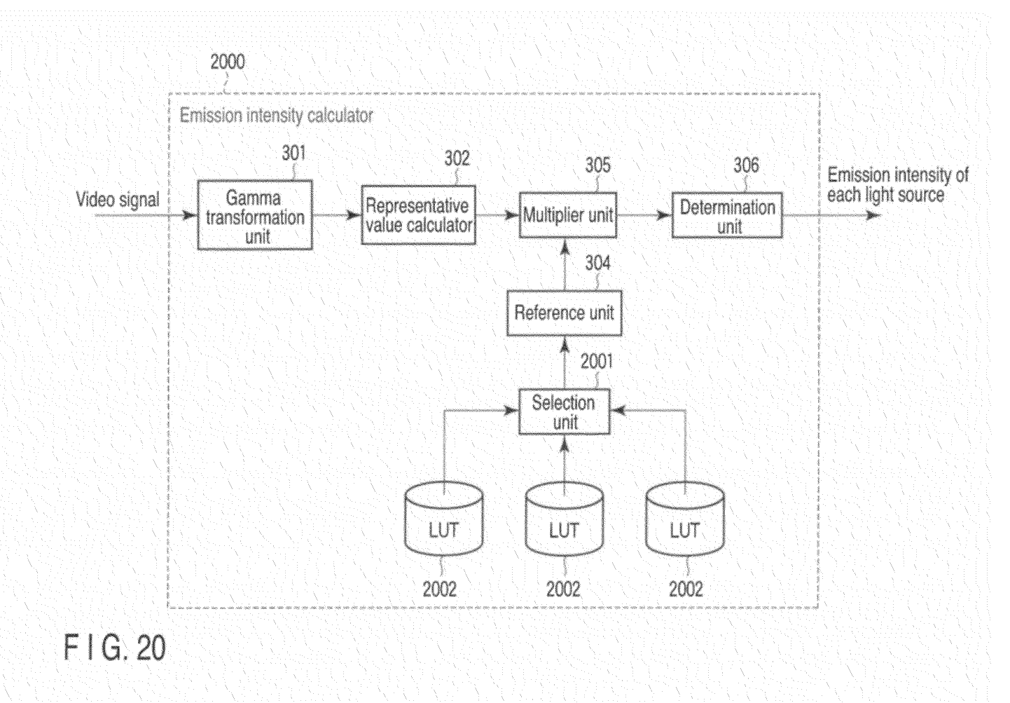

FIG. 20 shows the configuration of the emission intensity calculation unit 2000 according to the third embodiment. The emission intensity calculation unit 2000 of the third embodiment significantly differs from the emission intensity calculation units 101 and 400 in that the former holds a plurality of sets of predetermined lighting patterns, and includes the selection unit 2001. Although FIG. 20 shows an example in which three sets of predetermined lighting patterns are held, the number of sets of lighting patterns held in the emission intensity calculation unit 2000 of the third embodiment is not limited to it.

The emission intensity calculation unit 2000 of the third embodiment holds a plurality of sets of predetermined lighting patterns. In the example of FIG. 20, different LUTs 2002 hold different sets of lighting patterns as respective tables. The respective sets of lighting patterns correspond to, for example, display characteristics settings, such as high-contrast display and low-contrast display. Alternatively, the respective sets of lighting patterns may correspond to other display characteristics, such as brighter display and darker display.

Yet alternatively, the respective sets of lighting patterns may correspond to viewing environments, such as brighter viewing environment and darker viewing environment. Alternatively, they may correspond to the types of viewers, such as young people, middle-aged people and elderly people, or may correspond to viewing areas, viewing time zones, etc.

Yet alternatively, the respective sets of lighting patterns may correspond to video signal input devices, such as tuners, personal computers, game machines, recording/reproducing apparatuses.

Also, the respective sets of lighting patterns may correspond to video content categories, such as movies, TV dramas, sport programs, animation programs, documentaries, news and data.

The respective sets of lighting patterns may also correspond to the characteristics of display images, such as bright and dark video images.

The selection unit 2001 selects one of the sets of predetermined lighting patterns in accordance with an externally input selection signal, and inputs the selected set to the reference unit 304.

The emission intensity calculation unit 2000 of the third embodiment calculates the emission intensity of each light source suitable for displaying an input video signal, based on the lighting pattern selected in the selection unit 2001, as in the emission intensity calculation units 101 and 400 of the first embodiment.

As described above, the third embodiment employs a plurality of lighting pattern data items having different display characteristics, which enables desired lighting pattern data to be used to realize display optimal for display characteristics settings, viewing environments, video-signal input apparatuses, display image categories, display image characteristics, etc.

### Fourth Embodiment

An information processing apparatus and an image display according to a fourth embodiment significantly differ from those of the first embodiment in that in the fourth embodiment, an emission intensity calculation unit 2100 holds a plurality of sets of predetermined lighting patterns, and includes a plurality of reference units 304 and a combining unit 2101. Since the other structure of the fourth embodiment is similar to that of the first embodiment, no detailed description is given thereof.

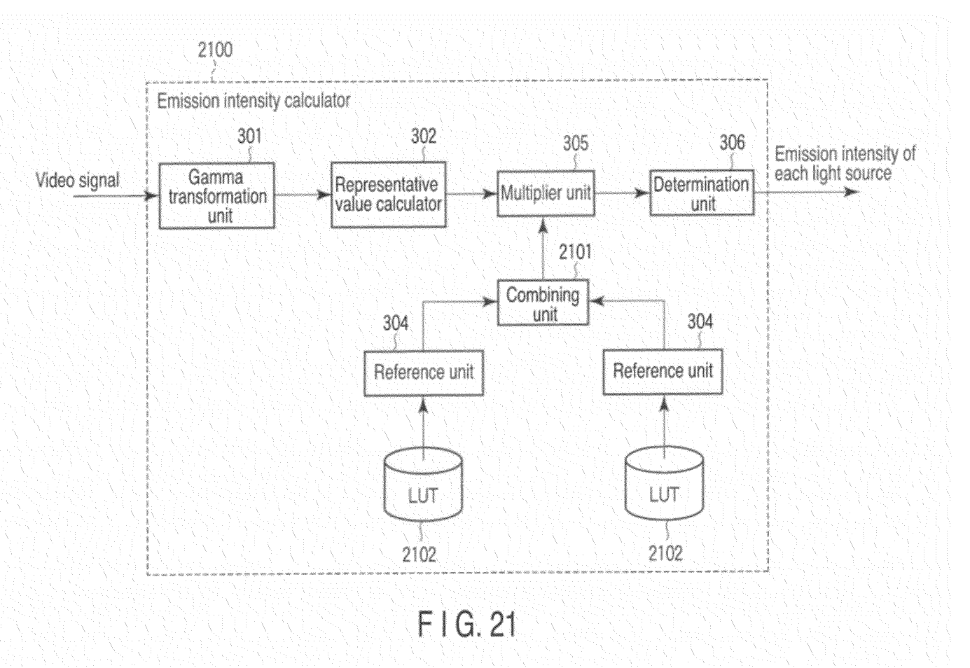

FIG. 21 shows the emission intensity calculation unit 2100 of the fourth embodiment. Although FIG. 21 shows an example in which two sets of predetermined lighting patterns are held, the number of sets of lighting patterns held in the emission intensity calculation unit 2100 of the fourth embodiment is not limited to it.

The emission intensity calculation unit 2100 of the fourth embodiment holds a plurality of sets of predetermined lighting patterns. The respective sets of lighting patterns correspond to, for example, display characteristics, such as high-contrast display and low-contrast display. Alternatively, the respective sets of lighting patterns may correspond to other display characteristics, such as brighter display and darker display.

Yet alternatively, the respective sets of lighting patterns may correspond to such viewing environments as described in the third embodiment. Alternatively, the respective sets of lighting patterns may correspond to such video signal input devices as described in the third embodiment. Also alternatively, the respective sets of lighting patterns may correspond to such video content categories as described in the third embodiment. Further, the respective sets of lighting patterns may correspond to such display image characteristics as described in the third embodiment. The reference units 304 of the fourth embodiment are similar in structure and operation as that of the first embodiment, and hence will not be described in detail.

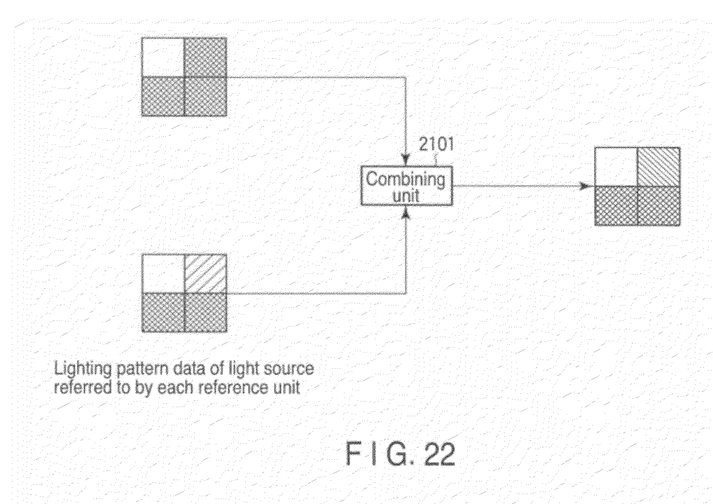

The combining unit 2101 of the fourth embodiment combines, for each light source, the lighting pattern data items referred to by the reference units 304. The operation of the combining unit 2101 will be described referring to FIG. 22. As shown in FIG. 22, the input to the combining unit 2101 is the lighting pattern data of each light source referred to by each reference unit 304. The output of the combining unit 2101 is the lighting pattern data as the combining result of the input pattern data for each light source. The combining in the combining unit 2101 is executed by, for example, the weighted average of the lighting pattern data of the light source referred to by each reference unit 304. More specifically, the combining of the combining unit 2101 is given by the following equation (6):

L_{PC}(i,j)=α₁·L_{P,1}(i,j)+α₂·L_{P,2}(i,j)+ . . . +α_{M}·L_{P,M}(i,j) (6)

where i is an index for identifying each light source, j is an index for identifying each small region, L_{p,1} (i,j), for example, is the value of the lighting pattern data corresponding to the i^{th} small region and referred to by each reference unit, M is the total number of the reference units, α₁, for example, is a weighing coefficient, and L_{pc}(i, j) is the combining result of the j^{th} small region corresponding to the i^{th} light source. The weighting coefficient set when the combining unit is constructed as the above may be predetermined or be an externally input value.

The emission intensity calculation unit 2100 of the fourth embodiment calculates the emission intensities of the light sources suitable for display based on an input video signal and the lighting pattern obtained by the combining of the combining unit 2101, in the same manner as in the emission intensity calculation units 101 and 400 of the first embodiment.

As described above, in the four embodiment, a plurality of lighting pattern data items corresponding to different display characteristics are used, and a desired number of lighting pattern data items are combined. For instance, the combining unit 2101 combines a set of high-contrast display lighting patterns and a set of low-contrast display lighting patterns, which patterns are included in a set of lighting patterns corresponding to setting of display characteristics. This can realize display suitable for setting of intermediate display characteristics between high-contrast and low-contrast display characteristics.

Further, high-contrast display under a bright viewing environment can also be realized if the combining unit is configured to combine, for example, a set of high-contrast display lighting patterns included in a set of lighting patterns corresponding to setting of display characteristics, and a set of lighting patterns for the bright viewing environment included in lighting patterns corresponding to viewing environments.

By virtue of the above structures, display more appropriate for display characteristics settings, viewing environment conditions, video signal input devices, display image categories, video image characteristics, etc., can be realized.

The flow charts of the embodiments illustrate methods and systems according to the embodiments of the invention. It will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instruction stored in the computer-readable memory produce an article of manufacture including instruction means which implement the function specified in the flowchart block or blocks. The computer program instructions may also be loaded onto a computer or other programmable apparatus to cause a series of operational steps to be performed on the computer or other programmable apparatus to produce a computer programmable apparatus which provides steps for implementing the functions specified in the flowchart block or blocks.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image display apparatus comprising:
a liquid crystal panel unit configured to display a video image in a display region;
a backlight unit including a plurality of light sources illuminating the liquid crystal panel unit, the light sources is configured to illuminate illumination regions into which the display region is tentatively divided;
a calculation unit configured to calculate a representative value of relative luminances of pixels in the each of small regions into which the display region is divided, the small regions being smaller than the illumination regions;
a reference unit configured to refer to prestored lighting pattern data items for the light sources, and select a referred light pattern data item in accordance with a position of each of the small regions in the display region;
a multiplier unit configured to multiply the referred lighting pattern data item by the representative value, for each of the small regions; and
a determination unit configured to determine emission intensities of respective light sources based on multiplication results of the multiplier unit.

2. The apparatus according to claim 1, the determination unit determines the emission intensities based on maximum values of multiplication results of the multiplier unit corresponding to the small regions.

3. The apparatus according to claim 1, wherein the lighting pattern data items referred to by the reference unit correspond to relative positions of each of the illumination regions of the light sources and each of the small regions.

4. The apparatus according to claim 2, wherein the reference unit refers to a same lighting pattern data item if relative positions of one of the illumination regions and one of the small regions are the same as relative positions of another of the illumination regions and another of the small regions.

5. The apparatus according to claim 1, wherein if at least part of a lighting pattern indicated by one of the lighting pattern data items exits outside an end of the display region, the at least part is folded along the end of the display region, and the reference unit refers to a lighting pattern data item corresponding to the at least part, and to a lighting pattern data item corresponding to another part of the display region on which the at least part is folded.

6. The apparatus according to claim 1, further comprising:
a selection unit configured to select a desired lighting pattern data item from lighting pattern data items included in the pattern data items and indicating lighting patterns of different display characteristics,
wherein the reference unit refers to the desired lighting pattern data item.

7. The apparatus according to claim 1, further comprising:
a plurality of reference units similar to the reference unit and configured to refer to lighting pattern data items included in the pattern data items and indicating lighting patterns of different display characteristics; and
a combining unit configured to combine the lighting pattern data items referred by the reference units,
wherein the multiplier unit executes multiplication using the combined lighting pattern data items.

8. The apparatus according to claim 1, wherein
the light sources are provided along sides of the liquid crystal panel unit; and
if the luminances of the light sources in the each of the small regions are calculated, the reference unit refers to lighting pattern data items included in the lighting pattern data items and indicating lighting patterns that differ in accordance with relative positions of the illumination regions of the light sources and the small regions.

9. An information processing apparatus wherein
a representative value of input video signals is calculated in each of small regions, divisions of a display region corresponding to illumination regions of light sources being divided into the small regions, the small regions being smaller than the divisions;
when a luminance of each of the light sources in each of the small regions is calculated, lighting pattern data preset in accordance with relative positions of the illumination region of each of the light sources and the each of the small regions is referred to.

10. An information processing apparatus comprising:
a calculation unit configured to calculate, for each of small regions, a representative value of relative luminances of pixels in the each of the small regions, the small regions being included in a display region of the information processing apparatus, and being smaller than illumination regions of light sources into which the display region is divided;
a reference unit configured to refer to prestored lighting pattern data items for the light sources, and select a referred light pattern data item in accordance with a position of each of the small regions and each of the illumination regions of the light sources;
a multiplier unit configured to multiply, for the each of the small regions, each value of the referred lighting pattern data item by the representative value; and
a determination unit configured to determine respective emission intensities of the light sources based on multiplication results of the multiplier unit.
